(19) United States
(12) Patent Application Publication
(10) Pub. No.: US 2012/0305338 A1
(43) Pub. Date: Dec. 6, 2012

(54) REGULABLE ELEVATOR BRAKE

(76) Inventors: Hans Kocher, Udligenswil (CH); Daniel Meierhans, Luzern (CH)

(21) Appl. No.: 13/483,400

(22) Filed: May 30, 2012

(30) Foreign Application Priority Data
May 30, 2011 (EP) 11168118.5

(51) Int. Cl. B66B 5/18

(52) U.S. Cl. 187/359

(57) ABSTRACT

An elevator brake includes a housing and a brake unit, which is movable in an axial direction on a path between a braking position and a starting position, which includes at least one pull unit, and which is moved at least by a first spring force of at least one brake spring. A movement in the axial direction against the spring force of the at least one brake spring is generated by a stroke unit, which generates a stroke, at the pull unit of the brake unit. The first spring force of the at least one brake spring is reduced by a second spring force of a compensating spring stressed by the stroke of the stroke unit.

### CROSS-REFERENCE TO RELATED APPLICATION

This application claims priority to European Patent Application No. 11168118.5, filed May 30, 2011, which is incorporated herein by reference.

### FIELD

The disclosure relates to elevator brakes.

### BACKGROUND

Elevator brakes on the one hand have to rapidly respond in the case of emergency and stop the elevator cage and the counterweight and on the other hand the elevator brakes have to operate as quietly as possible so that the noises arising when the elevator brake responds do not have a disturbing effect in the areas adjoining the elevator installation. Known elevator brakes comprise at least one spring or brake spring generating a braking force, wherein an electromagnetic device with at least one electromagnetic coil operates against the spring force and in that case keeps the brake in, inter alia, a starting position. If the voltage at the coil is switched off, the magnetic field collapses and the one brake unit of the elevator brake presses against, for example, a brake disc, elevator rail, etc., due to the spring force of the at least one brake spring. The brake unit in that case accelerates under the action of the spring force of the brake spring and presses against the brake disc in order to achieve a braking action. The brake unit usually presses from one side and a further brake unit from the opposite side against the brake disc.

In the case of an emergency it can be necessary for an elevator cage of the elevator installation to be moved to an evacuation story, for example for evacuation of persons who are trapped in the elevator cage. For that purpose the elevator brake has to be released. If, however, no power supply is available for the elevator installation the elevator brake cannot be released without consequent dropping of the elevator cage. In order to prevent dropping of the elevator cage, the elevator brake has to be controllable so that the elevator cage in the case of emergency can, for example, be safely moved to an evacuation story.

However, even in the case of normal operation of the elevator cage it can be useful for the elevator brake to be regulable, for example for smoother braking.

### SUMMARY

For at least some embodiments, for control or regulation of an elevator brake by means of a stroke unit, which generates a stroke, at a pull unit of a brake unit, a movement in axial direction against a first spring force is generated by means of a brake spring, wherein the first spring force of the at least one brake spring is reduced by means of a second spring force of a compensating spring stressed by the stroke of the stroke unit.

The elevator brake comprises at least one housing and at least one brake unit movable in axial direction on a path between a braking position and a starting position. In addition, the elevator brake comprises at least one brake spring which is disposed in operative connection with the movable brake unit and which can be arranged in the housing. The at least one brake spring exerts a first spring force on a movable brake unit. The movable brake unit is in operative connection with a pull unit. The at least one pull unit and the brake unit are either formed from one piece or connected together by way of suitable means, for example screws, by welding, by gluing, by means of a cable or similar, etc. The pull unit of the brake unit can be so arranged that it protrudes through the housing of the elevator brake, wherein it can be arranged centrally, decentrally, symmetrically, asymmetrically, etc., through the housing of the elevator brake. It is also possible for the pull unit to be arranged in a suitable construction outside the housing of the elevator brake. The pull unit can be, for example, a rod of metal, a cable, a wire cable, etc.

In principle any unit which can generate a stroke in axial direction can be used as stroke unit. Possibly, in that case use is made of a non-self-locking stroke unit.

Thus, for example, a ball cap unit, a trapezium thread unit, a non-self-locking thread, a spindle unit, etc., can be used as stroke unit. The brake unit with the pull unit is moved in axial direction against the first spring force of the at least one brake spring by means of the stroke unit. Through the second spring force of the at least one compensating spring, which can be disposed or arranged in or near the stroke unit, the amount of the first spring force of the at least one brake spring is reduced by the amount of the second spring force of the compensating spring.

The movement of the stroke unit and thus the axial movement of the brake unit can be carried out by means of at least one actuator connected with the stroke unit. However, the actuator can also be integrated into the stroke unit. In that case, a manually operable lever, a motor-spindle unit, a spindle unit, a motor, a hydraulic unit, a stroke magnet, etc., can be used as at least one actuator. The at least one actuator can, in some cases, be controlled or regulated by way of a control unit connected with the at least one actuator. It is thus possible for the stroke of the stroke unit to be regulated or controlled by way of the at least one actuator with the help of the control unit. The control unit can be, for example, an elevator control unit which is connected with the at least one actuator by way of a suitable communications network, whether by way of a line or not by way of a line. The control unit could obviously also be represented by a separate unit. The control unit can regulate or control the stroke of the stroke unit by way of the at least one actuator by means of analysis, evaluation or comparison of obtained data or parameters, for example position data, speed data, acceleration data, etc., which are transmitted from at least one sensor unit to the control unit by way of a communications network. It is thus possible for the elevator brake to be able to be regulated or controlled. As sensor unit in an elevator installation any unit can be used which can make available data or parameters necessary for regulation or control of the elevator brake. By way of example, an acceleration sensor, an incremental transmitter, an incrementing motor, a position sensor, a speed sensor, etc., comes into consideration as sensor unit.

An elevator brake frequently comprises at least one electromagnetic coil, wherein the at least one electromagnetic coil can be arranged in the housing. The electromagnetic coil is in that case used for holding the brake unit in a starting position. In the starting position no braking action by the elevator brake takes place. An additional possibility for reducing the first spring force of the at least one brake spring in the method according to at least some embodiments can be achieved in that in addition to the second spring force of the compensating spring use is made for that purpose of an electromagnetic force of the at least one electromagnetic coil. The at least one electromagnetic coil could also be used for the purpose of completely releasing the elevator brake, i.e. the magnetic force F_{M} is either with or without the second spring force F_{AF} greater than the first spring force F_{BF} of the at least one brake spring BF, and the force resulting therefrom is F_{N}=0. The first spring force F_{BF} is thus cancelled by the magnetic force F_{M} either with or without the second spring force F_{AF}. A release of the elevator brake thus means that the brake unit has no braking action and, for example, no longer has contact with the brake disc by the brake lining.

Not only the stroke of the stroke unit by way of the actuator, but also the magnetic force of the at least one electromagnetic coil can in that case be controlled, regulated or varied by the control unit.

In at least some embodiments, through the stroke unit, which acts on the brake unit, and the compensating spring, the first spring force of the at least one brake spring can be regulated and thus, for example, a reliable possibility for controlled movement or controlled lowering of an elevator cage to an evacuation story in the case of an emergency can be offered.

In further embodiments, in the case of an emergency a smoother braking without transgressing safety standards can be performed for the elevator cage.

### BRIEF DESCRIPTION OF THE DRAWINGS

The disclosure is explained in more detail on the basis of an exemplifying embodiment illustrated in the figures, in which:

FIG. 1 shows an elevator brake in a braking position,

FIG. 2 shows the elevator brake in a regulated braking position,

FIG. 3 shows the elevator brake in a starting position,

FIG. 4a shows a plan view of an exemplifying ball cap unit,

FIG. 4b shows a cross-section through the exemplifying ball cap unit in a starting position,

FIG. 4c shows a cross-section through the exemplifying ball cap unit in a stroke position,

FIG. 5 shows a braking diagram of the elevator pull brake,

FIG. 6a shows a further example of an elevator brake,

FIG. 6b shows a section through the z-y plane of the further example of an elevator brake and

FIG. 7 shows a control system for a regulated elevator brake.

### DETAILED DESCRIPTION

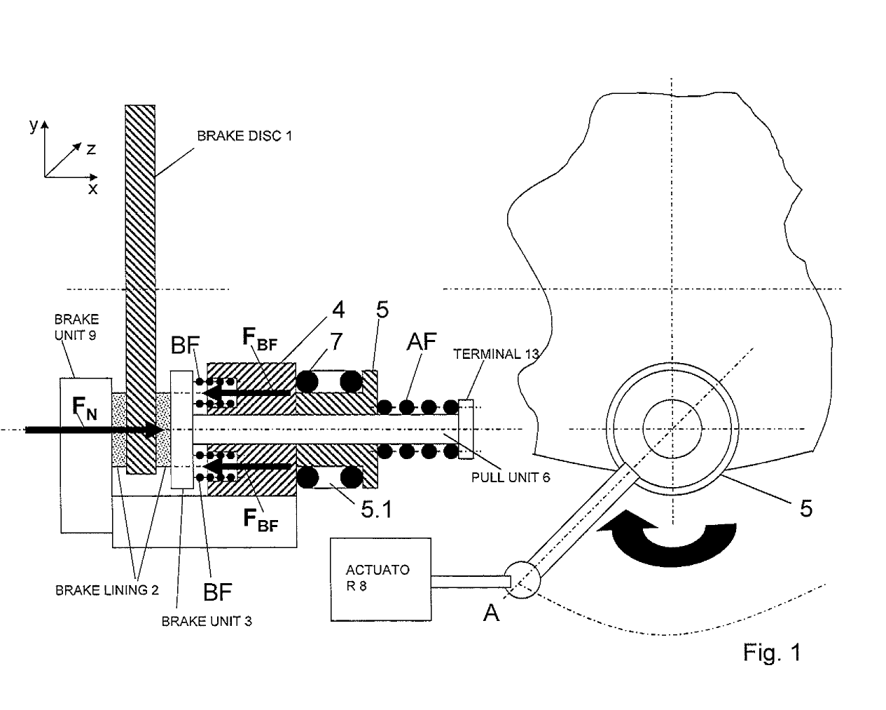

FIG. 1 shows an example of an elevator brake in a braking position. In this example the elevator brake comprises a housing 4 in which at least two brake springs BF for generating a further spring force F_{BF} are arranged, and a brake unit 3, which is movable in axial direction, with a brake lining 2. The brake lining 2 in the braking position presses, by virtue of the first spring force F_{BF} of the at least two brake springs BF, against a brake disc 1. On the opposite side of the brake unit 3 with a braking lining 2 a further brake unit 9 with a brake lining 2 presses against the brake disc 1. It is thereby possible, for example, to brake an elevator cage (not illustrated) of an elevator installation, for example in the case of an emergency.

The brake unit 3 is disposed in operative connection with a pull unit 6 and in this example is fixedly connected with the pull unit 6. The brake unit 3 and the pull unit 6 can be formed from one piece, for example by a casting, milling, punching, etc., or can be joined together by way of suitable means, for example by screw-connecting, gluing, welding, etc. In this example the pull unit 6 is of rod-like construction and can be made of plastics material, metal, ceramic, etc. The pull unit 6 can protrude through the housing 4 centrally or in centered manner. Arranged in connection with the housing 4 is a stroke unit 5.

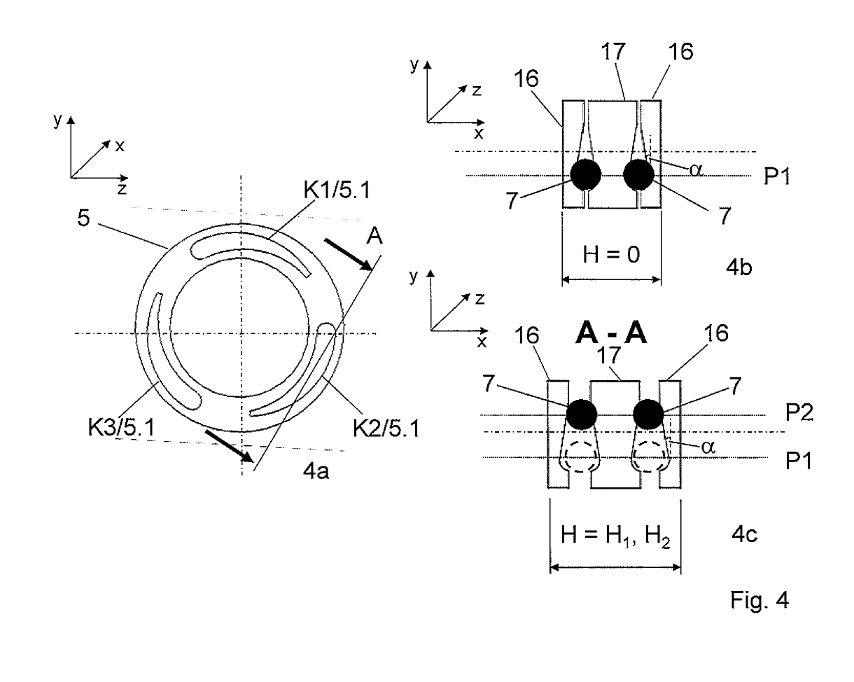

The stroke unit 5 is disposed in operative connection with the pull unit 6. Thus, it (5) can, as in this example, be arranged at or on the pull unit 6 so that a movement in axial direction of the pull unit 6 and thus of the brake unit 3 can be generated. The movement of the brake unit 3 or of the pull unit 6 is produced in that the stroke unit 5 generates a stroke or a movement in axial direction. How this stroke is generated depends on the stroke unit 5 used. Thus, for example, a ball cap unit, a hydraulic cylinder, a spindle unit, a trapezium thread unit, etc., can be used as the stroke unit 5. For generating the stroke the stroke unit for this purpose comprises at least one stroke generating unit 5.1. The stroke generating unit 5.1 can be a spindle unit, at least one ball cap as is described in FIG. 4, a screw unit, etc. In addition, the stroke unit 5 can enclose the pull unit 6 and be fixedly connected with the pull unit 6. In this example a ball cap unit with balls 7 of steel, plastics material, ceramic, etc., is used as stroke unit 5 for generating a movement in axial direction of the brake unit 3 or of the pull unit 6. By movement in axial direction there is to be understood a movement along the x axis in a Cartesian co-ordinate system. In some cases, it is possible for the stroke unit 5 to also generate a movement of the brake unit 3 or of the pull unit 6 in any spatial direction (x, y, z co-ordinates in a Cartesian co-ordinate system).

A compensating spring AF is stressed by the generated movement or the generated stroke of the stroke unit 5. For that purpose the compensating spring AF is disposed in operative connection with the stroke unit 5. The compensating spring AF can, as illustrated in this exemplifying embodiment, be arranged behind the stroke unit 5 on the pull unit 6. For that purpose the pull unit 6 has a terminal 13 so that the compensating spring AF can be stressed. It can be equally possible for the compensating spring AF to be integrated in the stroke unit 5 or in another unit of the elevator brake, for example in the brake unit 3, in an actuator 8, etc. In addition, it (AF) could also be arranged as a separate unit in the housing of the elevator brake.

Generation of the stroke or the movement in the case of the stroke unit 5 is usually effected by an actuator 8. Thus, the braking force generated by the first spring force F_{BF} of the at least one brake spring BF of the at least one brake spring BF can be controlled or regulated by means of the movement of the stroke unit 5. The actuator 8 can be a manual lever, but it is also possible to use a motor-spindle unit, a motor, a stroke magnet, a hydraulic unit, etc., as actuator 8. The control or regulation of the movement of the actuator 8 can be effected with the help of a control unit which is connected with the actuator 8, but not illustrated in this example. For that purpose the actuator 8 is connected by way of a suitable communications network, for example a wire-bound or wire-free communications network, a radio communications network, etc., with the control unit. An elevator control unit of an elevator installation or a separate unit can, for example, be used as control unit.

In this example the elevator brake is disposed in the braking position. This means that by virtue of the first spring force F_{BF} of the at least one brake spring BF the movable brake unit 3 presses by the brake lining 2 against the brake disc 1. At the opposite side of the brake unit 3 a further brake unit 9 presses by a brake lining 2 against the brake disc 1. The braking force of the first spring force F_{BF} of the at least one brake spring BF in that case corresponds with the oppositely acting normal force or resultant force F_{N} and thus the maximum braking force, i.e. F_{N}=F_{BF}.

In the braking position of the elevator brake no stroke or no movement is generated by the stroke unit 5. Thus, neither a movement of the brake unit 3 in axial direction is produced nor is the compensating spring AF stressed. The actuator 8 can in this situation be disposed in a position A, i.e. a starting position.

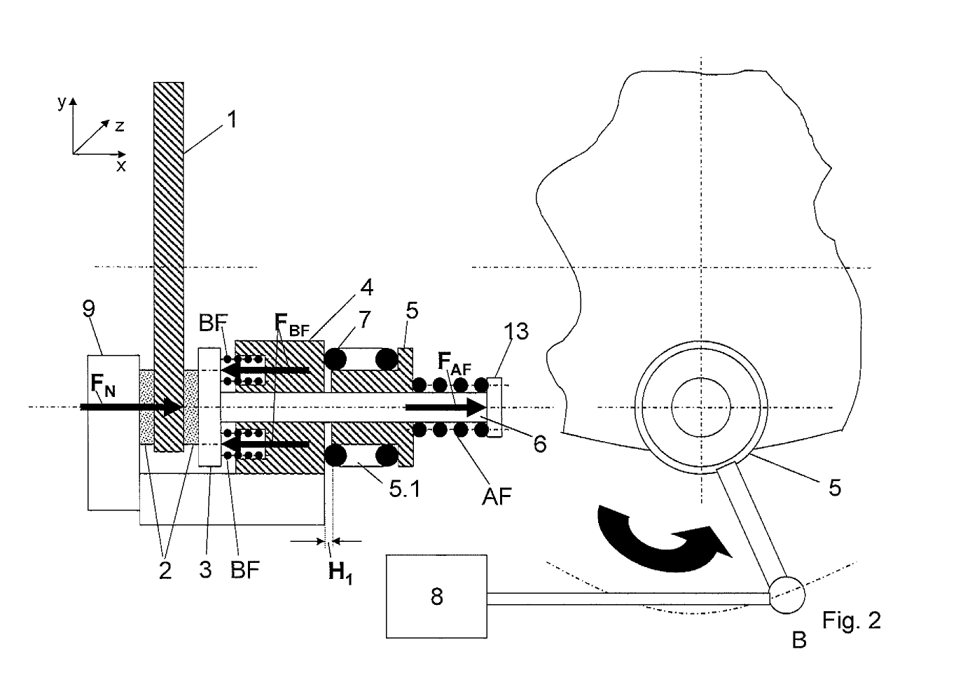

FIG. 2 shows the elevator brake, which is described in accordance with FIG. 1, in a regulated braking position. For that purpose the actuator 8 is brought into a position B which leads to generation of a stroke H₁ or a movement by the stroke unit 5, which stroke H₁ has the consequence of stressing of a compensating spring AF. In this example the stroke H₁ of the stroke unit 5 is generated by a ball cap unit. The larger the generated stroke H₁ of the stroke unit 5 the greater in that case the second spring force F_{AF} of the stressed compensating spring AF. The position B is not a discrete position. Rather, it is intended by that that in the position B a reduced, but nevertheless still present, braking action of the elevator brake is present.

By virtue of generation of the stroke H₁ of the stroke unit 5 the first spring force F_{BF} of the at least one brake spring BF or the amount of the first spring force F_{BF} is reduced by the second spring force F_{AF} of the compensating spring AF or by the amount of the second spring force F_{AF}. The resultant force F_{N} or the residual braking action can thus be described by the formula F_{N}=F_{BF}−F_{AF}.

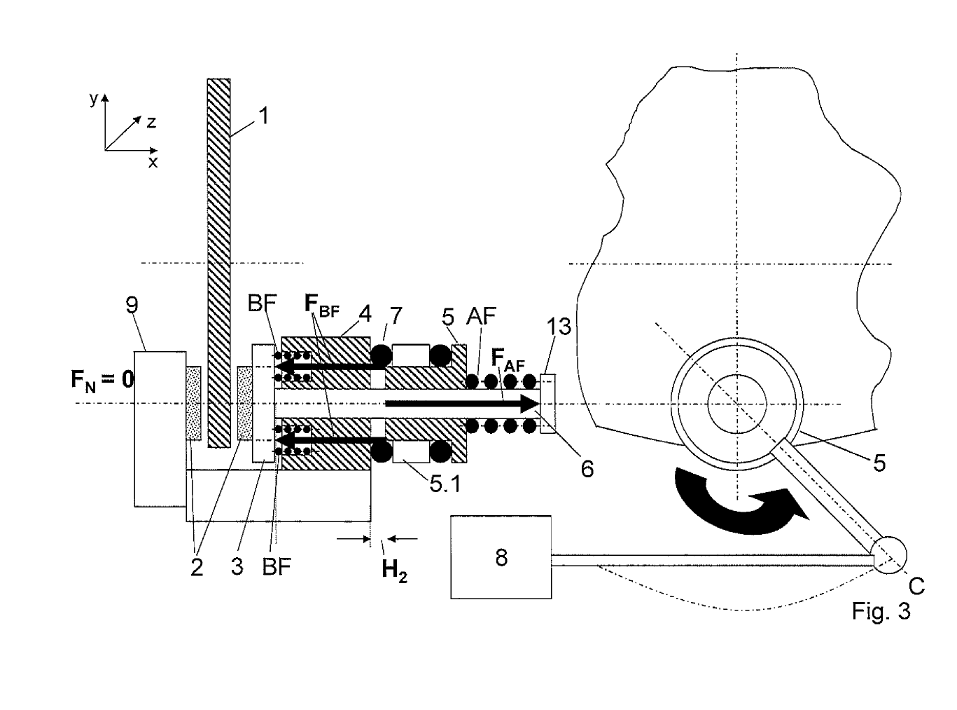

FIG. 3 shows the elevator brake, which is described in accordance with FIGS. 1 and 2, in a starting position. In this starting position there is no braking effect, i.e. the elevator brake is opened or released. This can be achieved in that the actuator 8 is brought into a position C so that the second spring force F_{AF} of the compensating spring is the same as or greater than the first spring force F_{BF} of the at least one brake spring BF. The resultant force F_{N} is in that case F_{N}=0.

Through the displacement or rotation of the actuator 8 into the position C the stroke unit 5 generates a stroke H₂ or movement of such a size that the brake unit 3 no longer has contact by the brake lining 2, which is moved in axial direction, with the brake disc 1 and the second spring force F_{AF} of the compensating spring AF in terms of amount is equal to or greater than the amount of the first spring force F_{BF} of the at least one brake spring BF. In addition, the brake unit 9 is in that case no longer pressed against the brake disc 1 by the brake lining 2, so that overall there is no braking action of the elevator brake.

FIG. 4a shows a plan view of an exemplifying ball cap unit with three stroke generating units 5.1 or caps K1, K2 and K3, such as can be used, for example, as the stroke unit 5. The ball cap unit has, for example, a circular shape in plan view.

As plan view there is meant in this example a section through the area (y-z plane) spanned by the y axis and the z axis of a Cartesian co-ordinate system. A ball cap unit basically consists, as illustrated in FIGS. 4b and 4c, of at least one first unit 16 provided with caps and ideally a second unit 17, which is used as cover unit for the first unit 16, and balls or rollers which are embedded usually in identical caps K1, K2 and K3 and thus are arranged between the first unit 16 and the second unit 17. A so-called double cap unit is illustrated in FIGS. 4b and 4c. A double-cap unit of that kind consists of two single cap units disposed one over the other. A double cap unit has on the one hand the advantage that a larger stroke can be generated and on the other hand that only the second unit 17 has to be moved or has to be rotatable relative to the first unit 16 and in that case the first units 16 can be designed to be secure against rotation. In this exemplifying embodiment the angle between a cap K1, K2, K3 is 120 degrees. Thus, it is to be understood that the caps K1, K2, K3 are arranged symmetrically on the circular area of the first unit 16. The number and angle between the caps K1, K2, K3 can be freely selectable. A respective ball of steel, plastics material, ceramic, etc., is embedded in the caps K1, K2, K3.

If the second unit 17 is rotated relative the first units 16 of the ball cap unit about the x axis, the balls or rollers are moved in the stroke generating units 5.1 or caps K1, K2, K3 from a first position P1 to a second position P2 and a stroke H thereby arises in the x axis in the case of the cap unit or stroke unit 5, which is used for the method according to FIGS. 1 to 3.

FIGS. 4b and 4c show a cross-section of the cap unit according to FIG. 4a along the line A-A through the cap K2 or the stroke generating unit 5.1. The cap K2 has in that case an inclination α. A ball 7 is disposed with its geometric center on a position P1 or in its starting position in the cap K2. In the starting position the stroke H of the cap unit is equal to zero (H=0). If, as described in FIG. 4a, the second unit 17 is rotated relative to the first units 16, the ball 7 moves from the position P1 or out of its starting position to a position P2, as is illustrated in FIG. 4c. A stroke H=H₁ or H₂ thereby arises, which in the case of a single cap unit is basically at most as large as the diameter of the ball 7 and in the case of the double cap unit appropriately larger.

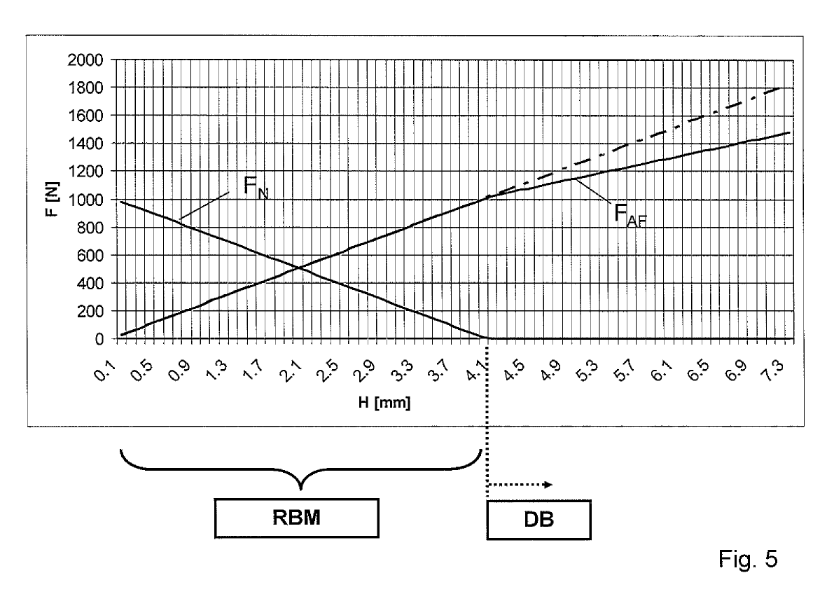

FIG. 5 shows a braking diagram of the elevator pull brake. A stroke H generated by the stroke unit 5 in accordance with FIGS. 1 to 4b is applied against a force F. In that case a plot F_{N}(H) of the normal force or resultant force and a plot F_{AF}(H) of the (second) spring force of the compensating spring AF arise.

If the spring force F_{AF} is greater due to generation of the stroke H, H₁, H₂ of the stroke unit 5, the braking action of the elevator brake progressively reduces, as can be seen on the basis of the region RBM. From a point DB there is no longer a braking effect. The theoretical course of the spring force F_{AF} is illustrated in the diagram by a dashed line. The resultant force F_{N} from the second spring force F_{AF} plus the first spring force F_{BF} is smaller than the theoretical spring force of the second spring force F_{AF}.

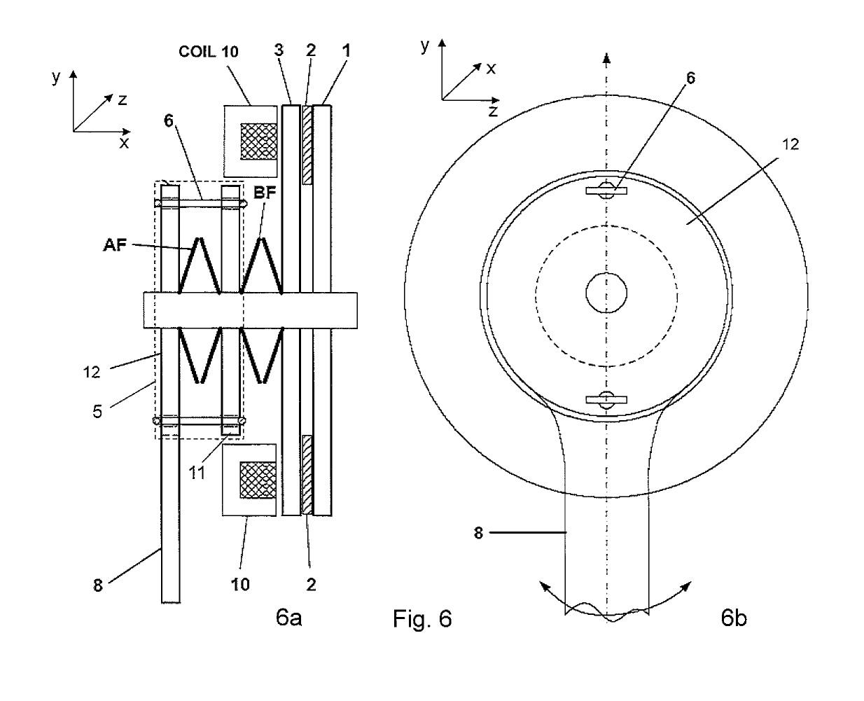

FIG. 6 shows a further schematic example for an embodiment of an elevator brake, as is described in FIGS. 1 to 3. For reasons of clarity no housing is shown in this exemplifying embodiment. The elevator brake comprises a brake unit 3 with a brake lining 2, which presses against brake disc 1 and thus achieves a braking action of, for example, an elevator cage. In an inactive position, i.e. the brake unit 3 does not press by the brake lining 2 against the brake disc 1, the brake unit 3 is held in the starting position by at least one electromagnetic coil 10. Instead of the at least one electromagnetic coil 10 use could also be made of a mechanical holding device for the brake unit 3.

The brake unit 3 is pressed by means of a first spring force of at least one brake spring BF—in this example the brake spring BF is formed as a plate spring—against the brake disc 1.

In order to regulate or control the elevator brake use is made of a stroke unit 5. This stroke unit comprises a first unit 11 which is connected with a second unit 12 by way of a pull unit 6, in this example being at least one cable, wire cable, synthetic material cable, etc. The first unit 11 and the second unit 12 can consist of metal, plastics material, ceramic, etc. The first unit 11 is connected with the brake unit 3 so that the pull unit 6 is disposed in operative connection with the brake unit 3. The form of the first unit 11 and the second unit 12 depends on the construction of the elevator brake and/or the kind of stroke unit 5. The second unit 12 additionally comprises an actuator 8, in this example being a manually operable lever. In various embodiments, use can also be made of an actuator 8 such as is described in FIGS. 1 to 3. In addition, instead of at least one cable, wire cable, etc., use could also be made of a spindle unit, a screw unit, a hydraulic cylinder, etc., as the pull unit 6. A compensating spring AF—in this example a plate spring—is disposed between the first unit 11 and the second unit 12.

Due to a movement of the stroke unit 5, i.e. a turning of the second unit 12 relative to the first unit 11, by the actuator 8 the brake unit 3 is moved by way of the pull unit 6 in axial direction and the compensating spring AF is stressed. The turning or rotation of the second unit 12 relative to the first unit 11 takes place in this example about the x axis. FIG. 6a shows a section through the x-y plane of a Cartesian co-ordinate system.

FIG. 6b shows a section through the z-y plane of the Cartesian co-ordinate system. The first unit 11 in the case of turning either does not rotate or rotates against the rotational direction of the second unit 12. The first spring force of the brake spring BF is thereby reduced by a second spring force of the compensating spring AF, so that the resultant force, as already described in FIGS. 1 to 5, is calculated from the formula F_{N}=F_{BF}−F_{AF}.

The reduction of the first spring force F_{BF} of the brake spring BF can take place, apart from use of the second spring force F_{AF} of the compensating spring AF, additionally in that an electromagnetic force F_{M} of the at least one electromagnetic coil 10 is used. This possibility for additional reduction of the first spring force F_{BF} of the brake spring BF can also be used in the exemplifying embodiment according to FIGS. 1 to 3. The at least one electromagnetic coil 10 could also be used for the purpose of entirely releasing the elevator brake, i.e. the magnetic force F_{M} is, either with or without the second spring force F_{AF}, greater than the first spring force F_{BF} of the at least one brake spring BF and the force resulting therefrom is F_{N}=0. The first spring force F_{BF} is thus cancelled, either with or without the spring force F_{AF}, by the magnetic force F_{M}. A release of the elevator brake means that the brake unit 3 does not produce any braking effect and, for example, no longer has contact by the brake lining 2 with the brake disc 1. For that purpose the elevator brake according to FIGS. 1 to 3 comprises at least one electromagnetic coil 10, which, for example, can be arranged in the housing 4.

The electromagnetic force F_{M} can be regulated by means of a control unit such as is described in FIGS. 1 to 3 and 7. The control unit could control or regulate not only the electromagnetic force F_{M}, of the at least one electromagnetic coil 10, but also the actuator 8 or the stroke unit 5. From use of the electromagnetic coil 10 and the compensating spring AF for control or regulation of the elevator brake there results as formula for the resultant force: F_{N}=F_{BF}−F_{AF}−F_{M}.

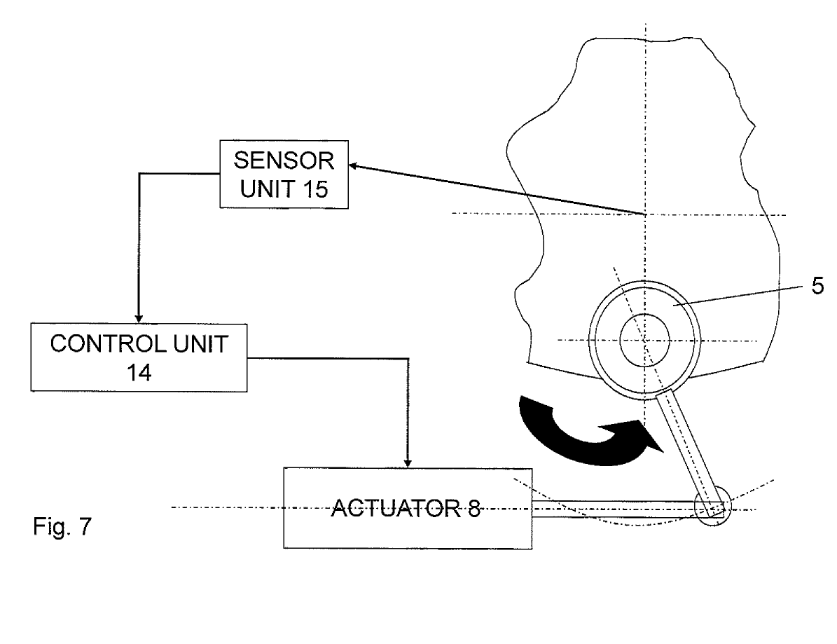

FIG. 7 shows a control system for a regulated elevator brake according to FIGS. 1 to 6. As described in FIGS. 1 to 6, a stroke H, H₁, H₂ is generated by the actuator 8 in the stroke unit 5 and thus the elevator brake is regulated. The control or regulation of the actuator 8 takes place through a control unit 14, which, for example, can be the elevator control or a separate control unit. In order to regulate or control the elevator brake the control unit 14 obtains data or parameters from at least one sensor unit 15. These data or parameters can be, for example, positional data or parameters, speed data or parameters, acceleration data or parameters, etc. Any sensor unit 15 which can supply the requisite data can be used as sensor unit 15. Thus, for example, an acceleration sensor, a position sensor, an incrementing motor or incremental transmitter, a speed sensor, etc., can be used. The control unit 14 controls the actuator 8 and thus the stroke unit 5 in dependence on a comparison, an analysis or an evaluation of data or parameters obtained by the sensor unit 15. The braking action or the retardation of the elevator brake is thus regulated. It is also possible for the control unit 14 to control or regulate the stroke unit 5 and/or the at least one electromagnetic coil of FIG. 6. The actuator 8 can be integrated in the stroke unit 5.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. A control method for an elevator brake, the elevator brake comprising a housing and a brake unit, the control method comprising:
using a stroke unit of the elevator brake, generating a stroke at a pull unit coupled to the brake unit, the brake unit being movable in an axial direction on a path between a braking position and a starting position;
as a result of the generating the stroke, moving at least one brake spring in an axial direction of the brake unit against a first spring force of the at least one brake spring; and
as a result of the generating the stroke, stressing a compensating spring to create a second spring force and reduce the first spring force.

2. The control method of claim 1, the compensating spring being arranged in or near the stroke unit.

3. The control method of claim 2, the stroke unit comprising a ball cap unit.

4. The control method of claim 2, the stroke unit comprising a non-self-locking thread.

5. The control method of claim 2, the stroke unit comprising a spindle unit.

6. The control method of claim 2, the stroke unit comprising a plate spring unit.

7. The control method of claim 1, the pull unit extending through the housing.

8. The control method of claim 1, the moving the at least one brake spring in the axial direction being performed using at least one actuator connected with the stroke unit.

9. The control method of claim 8, the at least one actuator comprising a manually operable lever.

10. The control method of claim 8, the at least one actuator comprising a motor-spindle unit.

11. The control method of claim 8, the at least one actuator comprising a stroke magnet.

12. The control method of claim 8, the at least one actuator comprising a motor.

13. The control method of claim 8, the at least one actuator comprising a hydraulic unit.

14. The control method of claim 8, the at least one actuator being coupled to an actuator control unit.

15. The control method of claim 14, the stroke unit being controlled by the actuator control unit.

16. The control method of claim 1, further comprising applying an electromagnetic force against the first spring force using an electromagnetic coil.

17. An elevator brake, comprising:
a housing;
a brake unit, the brake unit being movable in an axial direction between a braking position and a starting position;
a pull unit connected to the brake unit;
a brake spring, the brake spring exerting a force against the brake unit;
a stroke unit, the stroke unit generating a movement in the axial direction against the brake spring; and
a compensating spring, the compensating spring generating a force against the brake spring.
